(19) United States
(12) Patent Application Publication
(10) Pub. No.: US 2024/0323469 A1
(43) Pub. Date: Sep. 26, 2024

(54) DYNAMIC SUPPLEMENTAL CONTENT FOR RECORDED CONTENT

(71) Applicant: ARRIS ENTERPRISES LLC, Suwanee, GA (US)

(72) Inventors: Ramesh NARAYANASWAMY, Bangalore (IN); Sandeep Guddekoppa SURESH, Bangalore (IN)

(21) Appl. No.: 18/277,634

(22) PCT Filed: Feb. 15, 2022
(86) PCT No.: PCT/US2022/016397

§ 371 Date: Aug. 17, 2023

Related U.S. Application Data
(60) Provisional application No. 63/151,302, filed on Feb. 19, 2021.

(51) Int. Cl. H04N 21/2668; H04N 21/2187; H04N 21/234; H04N 21/414; H04N 21/4147; H04N 21/433; H04N 21/437; H04N 21/4722; H04N 21/643; H04N 21/81

(52) U.S. Cl. CPC H04N 21/2668; H04N 21/2187; H04N 21/23424; H04N 21/41407; H04N 21/4147; H04N 21/433; H04N 21/437; H04N 21/4722; H04N 21/64322; H04N 21/812

(57) ABSTRACT

An exemplary system provides dynamic supplemental content in a recorded content playback. The supplemental content are dynamically added to the recorded playback content which was streamed over IP using a MPEG-DASH format or related format. This allows a service provider to provide pertinent supplemental content to the end user and service provider.

### FIELD

The present disclosure relates to the display of video programs, more particularly to the presentation of targeted supplemental content for live and recorded programs in MPEG-DASH format.

### BACKGROUND

Media streaming of live and recorded programs has become increasingly popular. One type of media streaming, adaptive bit rate (ABR) streaming, is a technique used to stream media over computer networks. Current adaptive streaming technologies are almost exclusively based on HTTP and designed to work efficiently over large distributed HTTP networks such as the Internet. A variety of bitrate streaming solutions have been developed such as Dynamic Adaptive Streaming over HTTP (DASH), also known as MPEG-DASH, and HTTP Live Streaming (HLS). With DASH and HLS, media is streamed from conventional HTTP web servers. As Internet service providers (ISPs) and other similar vendors take advantage of these technologies and add capability to provide these streaming solutions, a need for a way to monetize a streaming service has developed.

A content creator or service provider may wish to insert supplemental content into a requested program (i.e., the primary content), such as alerts (e.g., alerts (e.g., Emergency Communication System, Amber, or other types of alerts), upcoming program notes, commercial communications, etc.) the display of which is usually recorded at least at initial display. For example, if a live channel is recorded and gets played on the same day, a service provider might count the display of the supplemental content. However, if the user waits a few days to play the recorded content, the service provider either does not track or get credit for the display supplemental content that was inserted into the streamed program, which can make sense particularly for content that might include alerts or other time sensitive information. It may be potentially no longer applicable or relevant.

A desire to count or track the play of the supplemental content during replay of the primary content over time creates a need for a service provider to find a technical solution to the technical problem of finding a practical way to dynamically insert supplemental content into streamed and recorded content based on dynamic criteria that results in the supplemental content being pertinent to, for example, the current day, time, content provider's and/or a user's preferences and profiles.

### SUMMARY

An exemplary system for providing supplemental content and media, includes a media device for providing programs to a client device. The system also includes both an external digital media server for storing and providing program content in the form of digital media, and a supplemental content server. The media device is configured to request and receive digital media from the external digital media server, and supplemental content from the supplemental content server. The media device then stores the digital media and supplemental content in storage associated with the media device. Supplemental content details are set by the media device based on one or more supplemental content criteria received from an external source.

Based on these criteria a combined media comprising the digital media and supplemental content is produced and stored for either immediate or later provision to a client's playback device and/or display.

An exemplary method of providing supplemental content and media, includes requesting digital media, by a media device, from an external digital media server. The media device then requests supplemental content from a supplemental content server. The method then includes receiving both the digital media from the external digital media server, and supplemental content from the supplemental content server. Both the digital media and the supplemental content are then stored in storage associated with the media device. The media device then sets supplemental content details based on one or more criteria received from an external source, and then produces a combined media comprising of the digital media and supplemental content. The combined media is then stored in the storage associated with the media device for either immediate or later provision to a client's playback device and/or display.

A non-transitory computer readable media is disclosed, having instructions operable to cause one or more processors of a media server to perform operations for providing supplemental content and media. The operations include requesting digital media, by a media device, from an external digital media server. The operations request, by the media device, supplemental content from a supplemental content server. The operations then include receiving both the digital media from the external digital media server and supplemental content from supplemental content server. Both the digital media and the supplemental content are then stored in storage associated with the media device. The media server then sets supplemental content details based on one or more criteria received from an external source, and produces a combined media comprising of the digital media and supplemental content. The combined media is then stored in the storage associated with the media device for either immediate or later provision to a playback device and/or display.

### BRIEF DESCRIPTION OF THE DRAWING FIGURES

The scope of the present disclosure is best understood form the following detailed description of exemplary embodiments when read in conjunction with the accompanying drawings. Included in the drawings are the following figures.

FIG. 1 is a block diagram of a digital media program distribution system, in accordance with an exemplary embodiment of the present disclosure.

FIG. 2 is a block diagram illustrating communication in a system between a content server or gateway and a plurality of end users or clients, in accordance with an exemplary embodiment of the present disclosure.

FIG. 3 is a block diagram of a digital program insertion (DPI) system, in accordance with an exemplary embodiment of the present disclosure.

FIG. 4 is a block diagram of an implementation of elements of a DPI system, in accordance with an exemplary embodiment of the present disclosure.

FIG. 5 is a functional block diagram of consumer premises equipment in the system of FIG. 2, in accordance with an exemplary embodiment of the present disclosure.

FIG. 6 is a flow chart of one example of operation of the system of FIG. 5, in accordance with an exemplary embodiment of the present disclosure.

FIG. 7A is an illustration of supplemental content stream formats in prior art DPI systems.

FIG. 7B is an illustration of an embodiment of supplemental content stream formats in an embodiment of a DPI system, in accordance with an exemplary embodiment of the present disclosure.

FIG. 8 is an action flow diagram of an embodiment of supplemental content insertion in a DPI system, in accordance with an exemplary embodiment of the present disclosure.

FIG. 9 is a block diagram illustrating communication in a system, including a digital media server, supplemental content server, media server, and client, in accordance with an exemplary embodiment of the present disclosure.

FIG. 10 is a representation of an MPEG-DASH (MPD) file, in accordance with an exemplary embodiment of the present disclosure.

FIGS. 11A and 11B are representation of MPDs with custom tags at the content server, in accordance with an exemplary embodiment of the present disclosure.

FIG. 12 is a flow diagram of one example of operation of the system of FIG. 9, for selectively changing part of the content on a MPD file, in accordance with an exemplary embodiment of the present disclosure.

### DETAILED DESCRIPTION

Exemplary embodiments of the present disclosure provide a system and method which provides a combined media containing both recorded content and advertisements. References to “one embodiment” or “an embodiment” do not necessarily refer to the same embodiment, although they may.

In the past few decades, advances in the related fields of video compression and video transmission systems have led to the widespread availability of digital video programs transmitted over a variety of communication systems and networks. Most recently, new technologies have been developed that have allowed television programs to be transmitted as multicast, e.g., IP multicast, digital bit streams of multiplexed video and audio signals delivered to users or client subscribers over packet switched networks.

Adaptive Bit Rate (ABR) streaming is a technology that works by breaking the overall media stream into a sequence of small HTTP-based file downloads, each download loading one short segment of an overall potentially unbounded transport stream. As the stream is played, the client (e.g., the media player) may select from a number of different alternate streams containing the same material encoded at a variety of data rates, allowing the streaming session to adapt to the available data rate. At the start of the streaming session, the player downloads a manifest containing the metadata for the various sub-streams which are available. Since its request uses only standard HTTP transactions, ABR streaming is capable of traversing a firewall or proxy server that lets through standard HTTP traffic. This also allows a content delivery network (CDN) to readily be implemented for any given stream. ABR streaming methods have been implemented in proprietary formats including HTTP Live Streaming (HLS) by Apple, Inc. HTTP Smooth Streaming by Microsoft Inc. as well as MPEG-DASH.

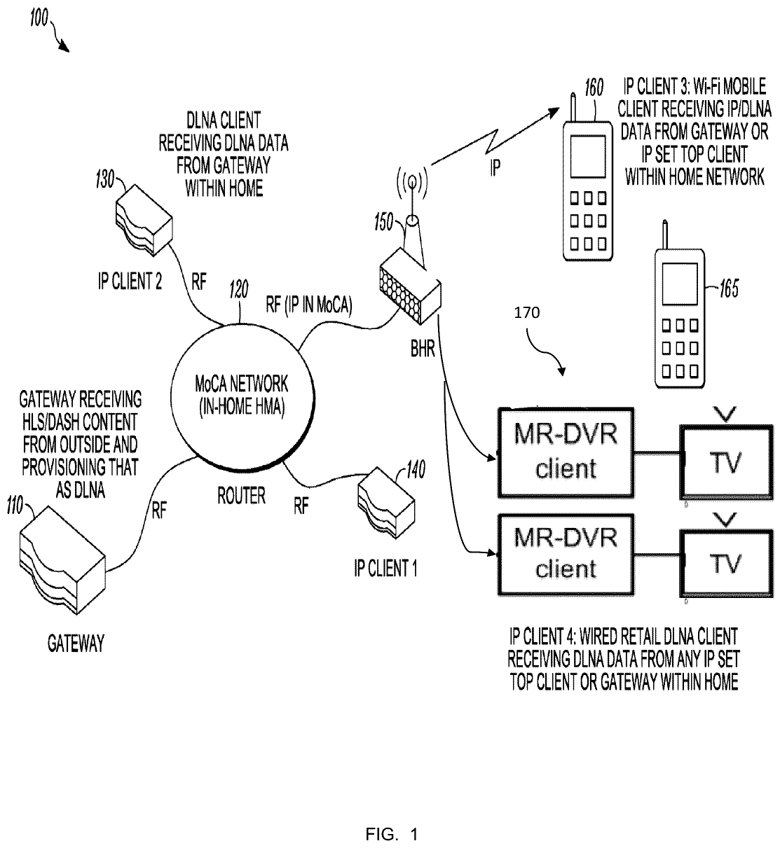

FIG. 1 is a functional block diagram illustrating communication in a system 100 between a content server or gateway 110 and a plurality of end users or clients in accordance with an embodiment. System 100 includes a gateway 110 configured to receive HLS/DASH content from a remote server and provision the HLS/DASH content. System 100, also includes a router 120, such as a multimedia over coax (MoCA) network. System 100 also includes an IP client-1 labeled 130 and the system 100 also includes an IP client-2 labeled 110. As shown, IP client-1 130 is configured to receive HLS/DASH content in the form of DLNA data from gateway 110. While the use of DLNA data is shown in FIG. 1, other known methods of sharing the digital media with the IP clients are conceived of or may be acquired from practicing of the disclosure, without departing from the breadth of scope.

The system 100 includes a broadband home router (BHR) 140. BHR 140 is in communication with an IP client-3 labeled 160 and 165, as well as IP client-4 labeled 170. IP client-3 160 may be a Wi-Fi mobile client configured to receive DLNA data or other forms of digital media from gateway 110 or IP set top client within home network 120. IP client-4 170 may be a wired retail client configured to receive digital media and other types of data from gateway 110 or IP set top client within home network 150. The IP client-4 170 include wired retail clients such as: a digital video recorder (DVR), a set-top box as is known in the art, a smart television, and/or other devices to receive data from the gateway 110.

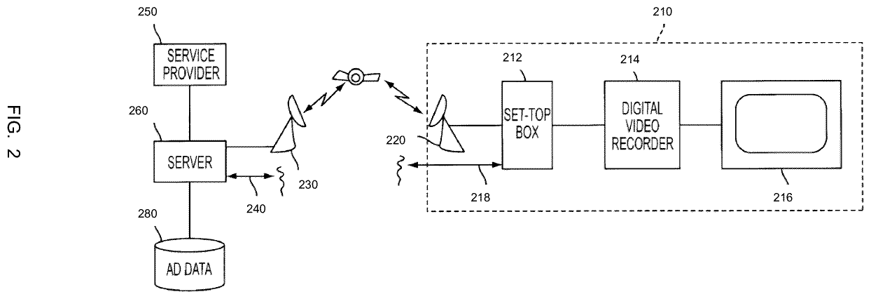

FIG. 2 is a simplified block diagram of a television program distribution. Customer premises equipment (CPE) 210 is exemplified as including television 216 coupled to a set-top box 212 via digital video recorder (DVR) 214. Set-top box 212, as is known in the art, contains processing capabilities for managing program viewing in response to user commands, as well as capability for transmitting and receiving data for television viewing. A suitable set-top box specifically designed or programmed for implement the disclosed method and system may be appropriate for the exemplified system. Data may be transmitted and received via satellite antenna 220 or via cable or other suitable connection 218.

The DVR 214 is a well-known device that has the capability to record and store video programs and to apply video data for display at television 216. Such video data may be stored data or data received from the set-top box 212. Both the set-top box 212 and DVR 214 are responsive to user commands in well-known manner, for example by receipt of signals of one or more remote controllers. Command types include, but not limited to, normal view, guide schedule view, pause, fast forward (at one or more speeds), rewind channel change and channel change.

A service provider 250 may include a television service media provider and television broadcast system. As shown, the service provider 250 is coupled to server 260 via a network connection. Alternatively the server can be incorporated within the service provider. Supplemental content data is stored in database 280, which may be located remotely from the server or incorporated there within. The server 260 is shown coupled to satellite antenna 230 and connection 240 for data communication with CPE 210.

A server 260 can serve as media server and it includes sufficient processing capability to implement analysis and operation functions required for identifying appropriate supplemental content data that is stored in database 280. The identified supplemental content data is transmitted to the client in response to a received request. The server 260 can also provide updated supplemental content data for CPE local storage.

The server 260 may include a variety of components including processors, storage, and networking components. The processor can be a CPU or other similar components as is apparent to persons having skill in the relevant art, including processors that may have one or more processor “cores”. The server may be composed of a plurality of engines and/or modules specifically configured to perform one or more functions of the media server. As used herein, the term “module” may be software or hardware particularly programmed to receive an input, perform one or more processes using the input, and provide an output. The input, output, and processes performed by various modules will be apparent to one skilled in the art based upon the present disclosure. Operations performed by the modules can be performed as a sequential process and/or be performed in parallel, concurrently, and/or in a distributed environment. According to an exemplary embodiment, the order of operations may be rearranged without departing from the spirit of the disclosed subject matter. The modules or engines included in the server 260 and elsewhere may be configured to execute program code or programmable logic to perform the functions discussed herein, such as may be stored in storage either associated with the server or other storage means.

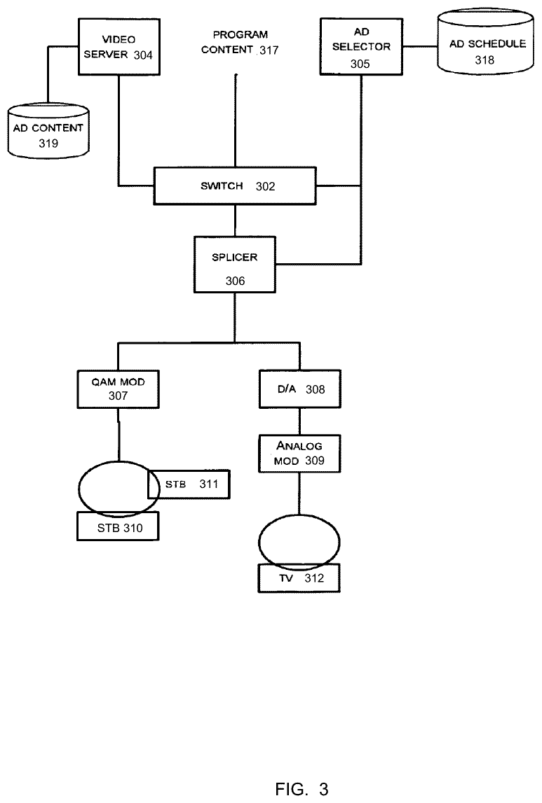

FIG. 3 is a block diagram of an embodiment of a digital program insertion (DPI) system. A program content 317, which has been encoded from a programming provider feed, such as a feed for a channel of television programming, is communicated, in this exemplary implementation, through a switch 302 to at least one splicer 306. A DPI system would typically have several such programming provider feeds, and may also have program content (such as video on-demand program content) streaming from one or more video servers.

The splicer 306 recognizes that a program insertion point will soon occur in the programming stream, for example by identifying a SCTE-35 cue packet in an MPEG-2 stream, a DTMF tone sequence in a digital or analog audio channel, a GPI contact closure from the equipment such as a satellite receiver, or via some other supplemental content insertion point indication. The splicer 306 contacts the supplemental content selector 305 with a request indicating that an supplemental content break is approaching for this program content 317, using an “supplemental content needed” message such as a SCTE-30. In some implementations, the splicer 306 may send a “supplemental content needed” message to the video server 304 instead. The video server 304 may then inform the supplemental content selector 305, that a supplemental content should be selected for insertion into the program content 317. In some implementations, functions of the video server 304 and the supplemental content selector 305 may be incorporated into one physical device, such as a stream serer with supplemental content selection capability.

When the supplemental content selector 305 receives a “supplemental content needed” message, it may determine a channel, program, and/or other information associated with the message. The supplemental content selector 305 may apply this information, and may also apply one or more supplemental content schedules 318 and/or other information, potentially obtained from an external source, as part of the process of selecting a supplemental content to be inserted into the content stream at the detected advertising break. For example, a two minute commercial break may typically be filled with four thirty-second advertisements. The supplemental content selector 305 may interact with the splicer 306 and/or the media server 304 (a.k.a., video server and/or supplemental content server) to cause the selected supplemental content to be inserted into the program stream at the supplemental content break.

The media server 304 may stream content files representing the selected supplemental content to the splicer 306, which may then splice (insert) the supplemental content into the program content. In some embodiments, the splicer 306 may also perform other functions, such as data modulation and stream multiplexing.

In the illustrated embodiment, the switch 302 provides communications connectivity between various system elements, including the video server 304, the encoded program content stream 317, the supplemental content selector 305, and the splicer 306. In some implementations, the switch 302 might include several networking elements, including Gigabit Ethernet, fiber networking connectivity, wireless networking switches, routers, buses, and/or other networking elements. Depending upon the implementation, some or all components may interact in ways that do not involve a switch 302.

The splicer 306 communicates one or more content streams with embedded advertising to analog and/or digital distribution network(s). In some implementations, a communications network will provide connectivity to the distribution network(s). The distribution network(s) may use some of the same devices, providing the connectivity to the splicer 306 such as the switch 302 previously discussed, or it may be distinct from those devices 302.

For analog distribution, a digital to analog converter 308 such as an MPEG-2 decoder may be employed. The resulting analog content stream may then be applied to one or more analog modulators 309 (e.g. to modulate and RF up-convert) prior to distribution to devices such as one or more televisions 312.

For digital distribution, a digital modulator such as a quadrature amplitude modulator (QAM) 307 may modulate and RF up-convert one or more digital content streams for distribution. Subscriber equipment such as set-top boxes 310, 311 may receive the content stream. Some types of subscriber equipment may be particularly suited for receiving digital distribution, analog distribution, or both.

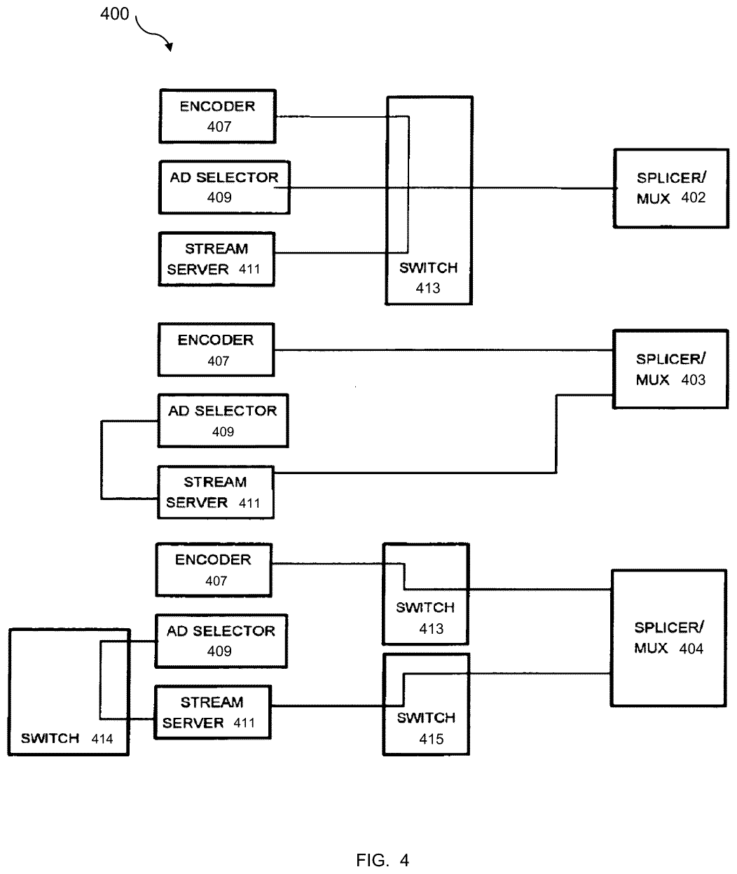

FIG. 4 is a block diagram of an embodiment of various implementations of elements of a DPI system 400. A video stream (such as for one or more television channels) is encoded into a digital content stream such as MPEG-2 by an encoder 407. The encoder may be located, for example, with the program creator, broadcast originator, or with the local content distributor (e.g. cable operator). The content stream is provided to a stream splicer/multiplexer 402, 403, and 404. The splicer/multiplexer 402, 403, and 404 recognizes a DPI insertion point (e.g. supplemental content break indication) in the content stream or streams and communicates a need for one or more supplemental content to a supplemental content selector 409 or to a stream server 411. When the stream server 411 receives a “supplemental content needed” message, it may communicate an indication to the advertisement selector 409. The advertisement selector 409 selects one or more advertisements. The stream server 411 streams the one or more supplemental content to the splicer multiplexer 402, 403, and 404, which inserts them into the channel's content stream at the appropriate point.

The top implementation (1) of FIG. 4 illustrates communications connectivity for the DPI components using a switch 413, such as a Gigabit Ethernet switch. The switch 413 could involve various networking implementations as discussed in conjunction with FIG. 3.

The middle implementation (II) of FIG. 4 employs non-switched connectivity between the DPI components. In this implementation, the splicer 403 may communicate a “supplemental content needed” message to the stream server 411, which interacts with the supplemental content selector 409. Non-switched connectivity is provided between the encoder 407 and the splicer/multiplexer 403, and between the stream server 411 and the splicer/multiplexer 403.

The implementation of FIG. 4 at the bottom of the figure employs separate communication paths or multiple networks via switches 414, 413, and 415. The separate communication paths or multiple networks support the high bandwidth requirements of streamed programming content form the programming encoders, distinctly from the high bandwidth requirements for streaming supplemental content from one or more stream servers. Separation of streaming content from headend information flows between the supplemental content selector and the stream server also helps ensure that transitory bottlenecks do not result in delayed information flows. The splicer/multiplexer 404 may interface with both switch 413 and switch 415 to receive content and supplemental content streams.

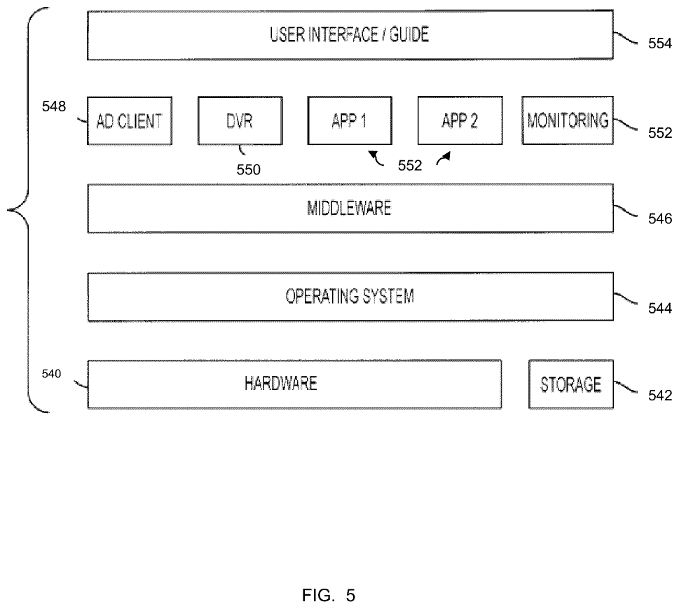

FIG. 5 is a block diagram of a control level diagram of consumer premises equipment in the system of FIG. 2. Hardware 540, which represents set-top box 212, DVR 214 and television 216, are operated under control of operating system 544. Middleware 546 interfaces controllers, such as supplemental content client module 548 DVR module 550 and application modules, collectively referenced 552. One such application 552 provides a monitoring function. The monitoring application may receive an indication of the channel currently being displayed, a channel change operation, content being displayed on a channel from a channel map or guide information stored on the customer premises equipment, and DVR operation, such as a fast forward, pause, rewind or normal playback speed mode. The fast forward speed and/or rewind speeds being used may also be provided, such as ffx2, ffx4, rwx2, rwx4. The monitoring application may provide this collected information at supplemental content client 548. User interface and guide block 554 represents interactivity with the user and program guide.

The CPE client is responsible for tracking viewing behavior. The client may also be provided with the capability for performing some of the analyzing functions discussed above that reside with the server. Viewing behavior is captured by the CPE client as the user navigates through channels, voice on demand (VOD) libraries, guide elements, or any other navigational elements that are part of the viewing experience. The client contains triggers that may guide it as to which behaviors to capture and which ones to send to the server. Alternatively, all behavior can be captured and sent to the server. For example, a trigger may be used to tell the client that when a user presses pause on the remote controller, such event requires notification to the server for determination of a suitable advertisement. As another example, entry by the user of a specific VOD library, such as action movies or search for a particular actor, would effect a trigger. The server can then identify a supplemental content that is most appropriate to the viewer's behavior and that supplemental content will be displayed at the most appropriate place and time. The supplemental content could be a simple banner of supplemental content (e.g., score of an ongoing game, alerts of various kinds, programming notes, commercial communications) inserted in to the VOD library user interface or an overlay on top of the screen to grab the user's full attention. An overlay may be in the form of a transparent or opaque display and or may be imposed on a resealed video program or interested by a video replacement.

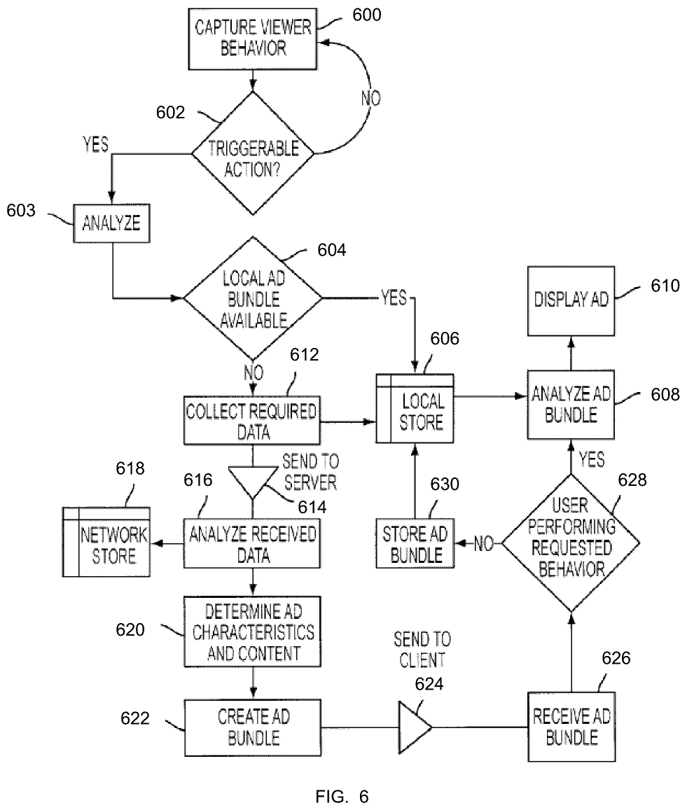

FIG. 6 is a flow chart representing one example of preferred embodiments for operation. At step 600, the processor at the consumer premises recognizes and captures viewer behavior. Such behavior would include channel and schedule surfing, and video recorder operations selected by the user. At step 602, determination is made whether the behavior captured in step 600 is appropriate to trigger action for presentation of appropriate supplemental content. If not, the flow reverts to step 600 to await detection of additional viewer behavior.

If it is determined in step 602, that a supplemental content presentation is appropriate, monitored viewer behavior may be analyzed at step 603 to identify suitable format for the supplemental content. The analysis may assess whether or not a locally stored bundle contains supplemental content appropriate to the viewing behavior or related to subject matter content. For example, a sport related supplemental content would be suitable for a sport program, a feminine hygiene supplemental content may be suitable for a female oriented program, a children's supplemental content for a children's program. Supplemental content may appropriately correspond to a television program rating assigned by a program rating system, for example, “G” for general audience, “PG” for parental guidance. Information characterizing a program may be obtained from guide information or a program map stored in the consumer premises equipment (CPE). Additional source of information for analysis may include key words in the title of the program or the type of program associated with a program title.

At step 604, determination is made whether a locally stored supplemental content bundle is available. In response to a positive determination in step 604, the local store is accessed at step 606. A local store 606 may comprise any known computer readable medium. At step 608, analysis is made of the stored supplemental content bundle and an appropriate supplemental content is selected for display at step 610. If it is determined at step 604 that there is no available supplemental content bundle in local storage, data that are required for developing an appropriate supplemental content library in local storage are collected at step 612. Such data may include the type of viewing behavior that was identified and the nature of viewing subject matter content if available. The collected data may be transmitted to the head-end server in real time or may be stored in local storage 606 for later transmission. The later transmission may occur during decrease usage times of the network to avoid bandwidth congestion.

At step 614, the collected data is transmitted by the set-top box to the head-end server with a request by the CPE client to provide appropriate advertising data. At step 616, the server analyzes the received data, and accesses storage for collected advertising data at step 618. The advertising data storage may be located at the server and/or at a remote network location. At step 620, determination is made at the server of received advertising regarding its characteristics and content. If it is appropriate and relevant to the viewing behavior data received from the CPE client, a supplemental content bundle is then created at step 622 and transmitted to the CPE at step 624. Those of skill in the art, will appreciate that the transmission may occur in real time or during decreased usage times of the network to avoid bandwidth congestion or at a time prior to when a user may be anticipated to perform a triggering event to insert an advertisement.

The supplemental content bundle is received by the CPE at step 626. At step 628, determination is made as to whether the user is still performing the viewing behavior for which the request for advertising data was made. If so, the process flow reverts to step 608 for analysis with respect to the supplemental content bundle received at step 626. If it is determined at step 628 that the viewing behavior has changed, the supplemental content bundle received at step 626 is stored locally at step 630 for future use as step 606 and the process flow reverts to step 600.

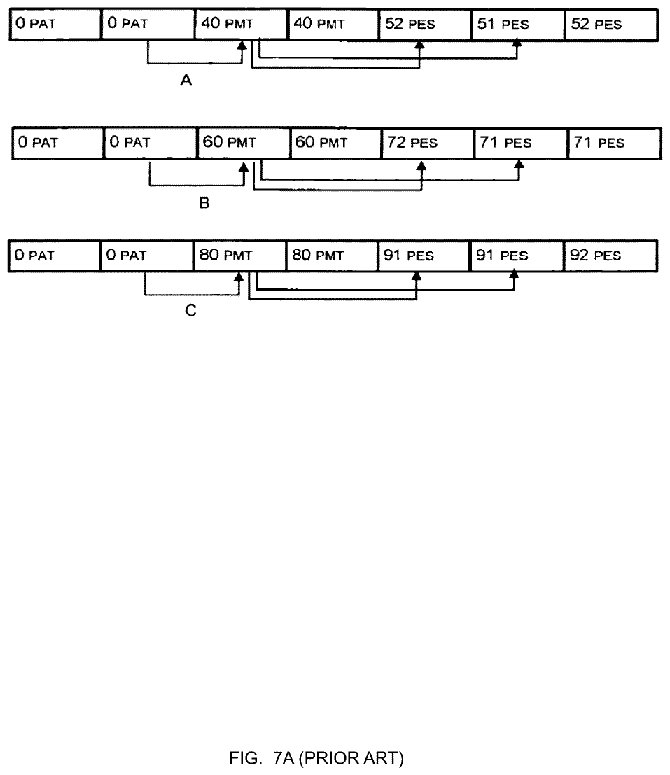

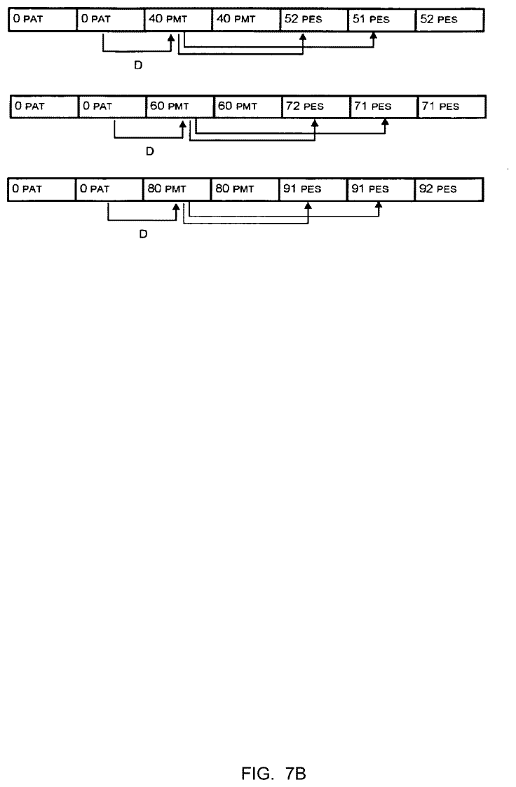

FIG. 7A is an illustration of an embodiment of supplemental content stream formats in a prior art DPI system. The discussion which follows assumes the packet streams A, B, and C, are each a Single Program Transport Stream (SPTS). However, the discussion would be equally valid if each packet stream A, B, and C were a Multiple Program Transport Stream (MPTS). In the top illustration, packets of a SPTS for a supplemental content “A” are shown. The numbers shown are the Program Identification (PID) numbers. The packet PIDs provide a way of identifying the type of packets in a programming stream. For MPTS, they also enable all packets for one programming stream to be identified.

The first two packets shown have a PID of 0 which indicates they contain a Program Association Table (PAT). One of the two PATs may be a “flush” PAT, which alerts the reader of the SPTS that a PAT containing new or changed information is coming. The second PAT contains a pointer (by identifying the PID), to the Program Map Table (PMT). In this case it identifies the PMT PID as 40.

In the MPTS, the PAT would still be sent identifying the PMT for this program stream as having PID 40. However, that PAT would also contain information identifying the PMT PIDs for the other programs in the MPTS.

The next two packets shown have a PID of 0. These are PMT packets, as the preceding PAT indicated the PMT would be delivered with PID 40. The first PMT may be a “flush” PMT, which alerts the reader of the SPTS that new or changed PMT information is to follow in a second PMT. Inside the PMT, video packets for the program are identified as PID 52 and audio packets as PID 51. Video and audio packets are content packets, in Packetized Elementary Stream (PES) format.

In addition to the packets shown for supplemental content A, B, and C, the content streams will typically include many other PES packets. The inclusion of flush PATs and PMTs in the content streams is optional.

The SPTS content stream for supplemental content B comprises PID 0 Pat, PID 60 PMT, and PID 72 and 71 PES packets. The SPTS content stream for supplemental content C contains PID 0 PAT, PID 80 PMT, and PID 91 and 92 PES packets.

FIG. 7B is an illustration of an embodiment of supplemental content stream formats in an embodiment of a DPI system. All packets shown in FIG. 7B are part of one SPTS stream. From the standpoint to the receiver, such as a splicer, all packets are for a single content stream from particular supplemental content. The top illustration shows packets used when program content for supplemental content A is streamed. The packets include a PID 0 PAT, PID 40 PMT, and PID 51 and 52 PES. Many other packets would typically be present as well.

The point where streaming of content for supplemental content A concludes, and streaming of content for supplemental content B commences, is treated as a transition, and at least one PID 0 PAT 0 packets are sent. The illustration for the supplemental content B portion of the stream is shown in the middle illustration. The PAT identifies PID 60 as comprising the PMT, which indicates the PES packets will now by PID 71 and PID 72. A receiver of the SPTS reads these packets and identifies the PES packets of the SPTS as having PID 71 and PID 72. Although the receiver may recognize that a transition has occurred, this has the effect of a transition within the SPTS for supplemental content D, not a new content stream.

Packets of the supplemental content C content are shown in the lower illustration. Packets have PID 0, and PMT has PID 80, and the media PES packets have PIDs 91 and 92.

Transitions within the SPTS from the content of supplemental content A to the content of supplemental content B and C are accomplished by adjusting the stream PAT packets, with relatively low overhead, thus increasing DPI system efficiency.

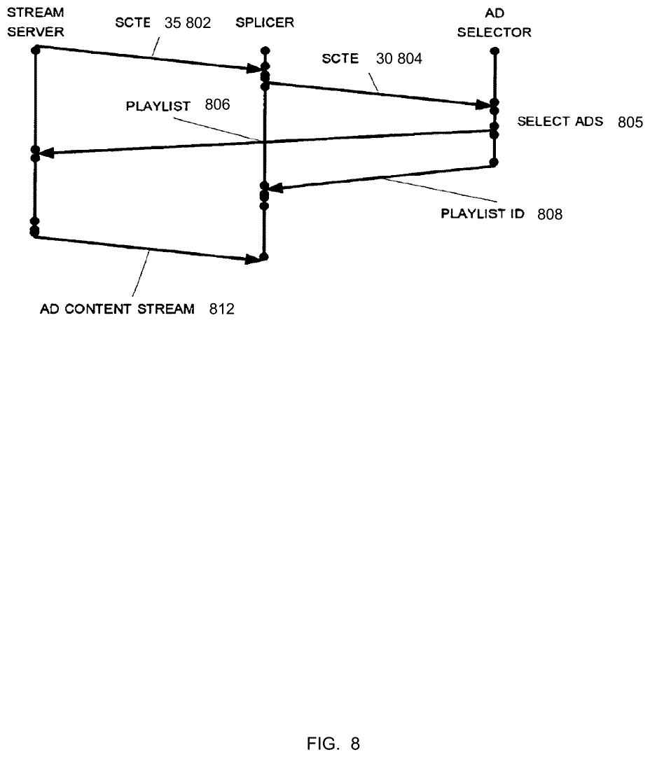

FIG. 8 is a flow diagram of an embodiment of supplemental content insertion in a DPI system. In this diagram, it is assumed that at least one stream server (not necessarily the same one) is used to send both programming content and advertising content to the splicer. In some implementations, an encoder, separate from a stream server, may be streaming the program content (e.g. from a satellite feed, upstream content source via fiber, etc.)

At 802, a stream server (as mentioned, this could be a “live” feed encoder) sends an SCTE-35 as part of a stream, e.g. as an MPEG data PID, indicating an upcoming supplemental content break in the stream.

The SCTE-35 is recognized by a receiving splicer. At 804, the splicer sends an SCTE-30, indicating the supplemental content break, to a supplemental content selector or supplemental content server (e.g. stream server with supplemental content selection capability). The supplemental content selector may respond to the splicer with an indication that the message was received and that the supplemental content selector is ready. At 805, the supplemental content selector selects one or more supplemental content to insert in response to the supplemental content break. At 806, the supplemental content selector informs the stream server of a playlist. The playlist identifies one or several supplemental content to provide as a SPTS, e.g. representing a single supplemental content stream. Playlists may reference other playlists, or for example file paths and/or URLs identifying files comprising the content of the supplemental content to insert at the supplemental content break.

The supplemental content selector may notify the splicer that the playlist file will be streamed to fill the supplemental content break. This may be accomplished using SCTE-30 messages, or messages similar thereto. In some situations, the video server (stream server) may provide such notification to the splicer. The splicer may respond to the supplemental content selector/server with an indication that it is ready to receive the playlist file stream, using an SCTE-30 message or one similar thereto. At 808, the supplemental content selector provides a playlist identification to the splicer. At 812, the supplemental content is streaming form the stream server to the splicer. The stream to insert at the supplemental content break, possibly including content from multiple supplemental content files, is received by the splicer as a single SPTS. The splicer may send two splice-progress indications to the supplemental content selector/server via SCTE-30, one at the beginning of the splice of the SPTS and one at the end. A substantial reduction in signaling overhead is thus accomplished over providing the supplemental content as three separate SPTSs. The supplemental content selector/server may comprise logic to interpret the receipt of the second progress indication as an indication that the multiple supplemental content were successfully spiced.

If the splicer comprises “playlist aware” logic, it may send two progress indications for each set of supplemental content of the SPTS (e.g. using PIDs or some other technique to identify the content of each supplemental content within the SPTS). The splicer may comprises logic to receive from the supplemental content selector/server information about the content of the playlist in order to make a determination of beginning and/or endpoints of particular supplemental content in the playlist. Substantial signaling overhead is obtained in this implementation as well, due to the reduced overhead of providing a single SPTs.

Although the implementation is exemplified by client and server implementation, the disclosed invention is not limited to this implementation alone. The server is responsible for analyzing captured user behavior and determining the most suitable advertising format, for example, full length clip, static banner, dynamic moving banner, audio only, as well as the means of display on the user's television screen (including placement, overlay), supplemental content duration, means for transmitting the supplemental content to be used (such as in band, out of band) and any related interactive elements to be provided with the aid. The server receives requests from the CPE client based on the user's behavior. Once the server receives the client requests it parses the information and begins processing in order to find the most suitable supplemental content format and means of display. The server may store these behaviors to build a history per CPE to help in better targeting and promotion of content or simply for analysis purposes. The server may be able to predict future behavior and create shortcuts that allow it to send predetermined supplemental content at predetermined locations to speed up operation. For example, if the service provider would like to promote a new show with a simple banner advertisement, a shortcut bundle can be created that will cause, automatically and without analysis the bundle to be displayed whenever fast forward behavior is detected.

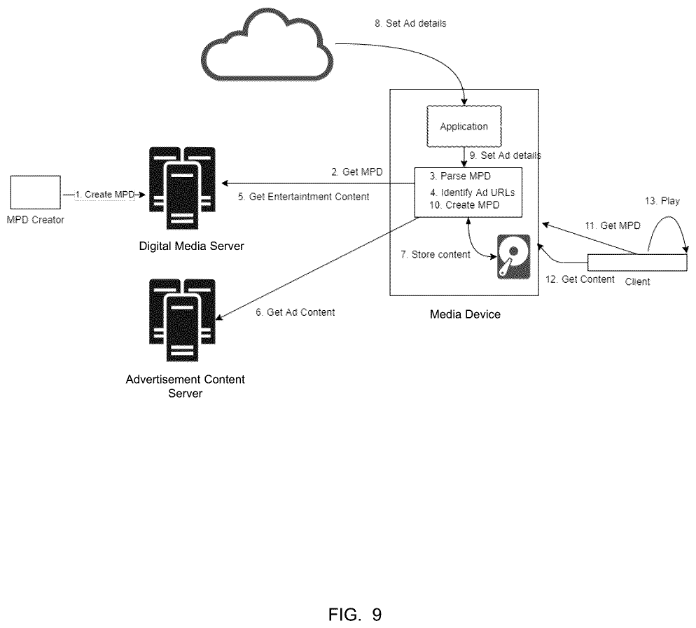

FIG. 9 shows a block diagram of a system according to a simplified block diagram of a system for providing supplemental content and media. The system includes an original media creator which creates Media Presentation Description files (MPD files). MPEG-DASH uses MPD files (Media Presentation Description—files with extension .mpd) to describe different components of the program, which provides digital media to a digital media server. A supplemental content server is also present which is similar to that of 280 in FIG. 2. From the cloud or other external source, supplemental content criteria is received that sets the supplemental content details.

When a user selects a show or content they wish to view on a client device, it requests a MPD from a media device. The client device can take the form of any device that a user can view or listen to digital media on. Such devices are, but not limited to: television, smart phones, smart watches, gaming devices, radios, MPEG players and other well-known forms of user equipment. The media device can be any of, but not limited to: a media server, cable headend, application server, set-top box, smart television, radio access network (RAN), gateway, router, and other well-known devices.

The media device creates the MPD file dynamically or in real-time, every time a client requests playback of the content. The content can take the form of a live event or real-time event/program such as a sports program or the content can take the form of previously recorded content such as a movie. The media device requests, upon receiving a request for a program from the client, digital media from the external digital media server, supplemental content from the supplemental content server. The supplemental content can take the form of a MPEG recording, supplemental content URLs, or an additional MPD file. The digital media is parsed and stored on storage associated with the Media device. The storage can take the form of internal storage or external storage. Some examples of internal storage are hard drives, flash drives, RAM, ROM, solid state drives (SSD) and other well-known forms of storage.

Once the media device receives the content from both the digital media server and supplemental content server, it parses the MPD of the content to get the content URLs and other details. Further as described above, it determines where supplemental content should/can be inserted into the content. The media device accesses operator cloud servers or other external network to provide appropriate information to set the supplemental content criteria for setting the specific supplemental content to be inserted into the content. The criteria can be based on the specific day, time, and/or preferences set by at least one of the operator's, ISP's advertiser's, clients', and other concerned party's preferences and profile. Alternatively, a potential option can be given to the client/user to eliminate or decrease the amount of advertisements, often based on the requirement for additional fees to be paid to the operator.

Based on the criteria received from the external network or operator cloud servers, the media device then creates the MPD with the appropriate supplemental content. This MPD is then forwarded to the requesting client device. The client can then play the content either in real time or from the stored content in the media device.

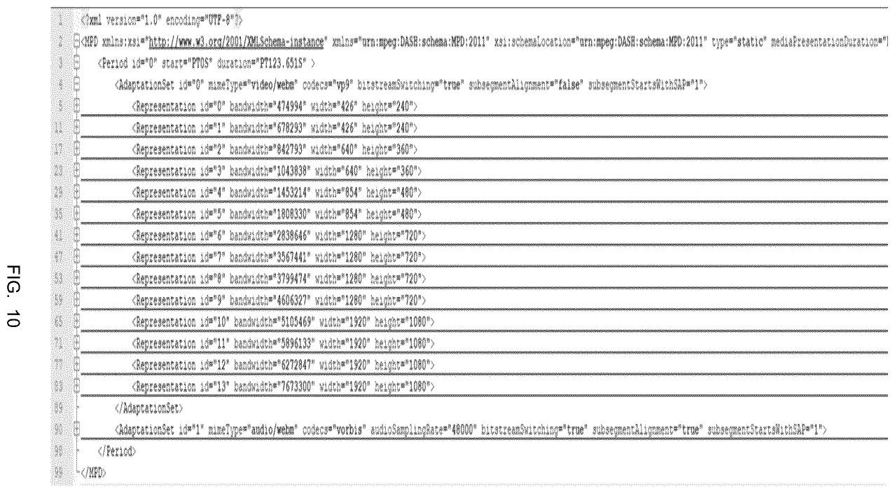

As shown in FIG. 10, the MPD file is essentially a description of the content, different formats available and different constituents of the program. The high-level parts of MPD files are an adaption set and then different representations inside of that. There are different attributes or elements possible for adaption sets and as well as for the representation. To distinguish the supplemental content at the recorder or player, custom attributes are added at the level of the adaptation set. Some possible attributes that would be useful are (for example, advertisements):
advertisementContent=“true” (alternatively periodType=“ad” or periodType=“entertainment”)
advertisementType=“automotive”
adPreferredPlaybackTime=“10/10/2020”
adDuration=“PT5.4S”
and many more.

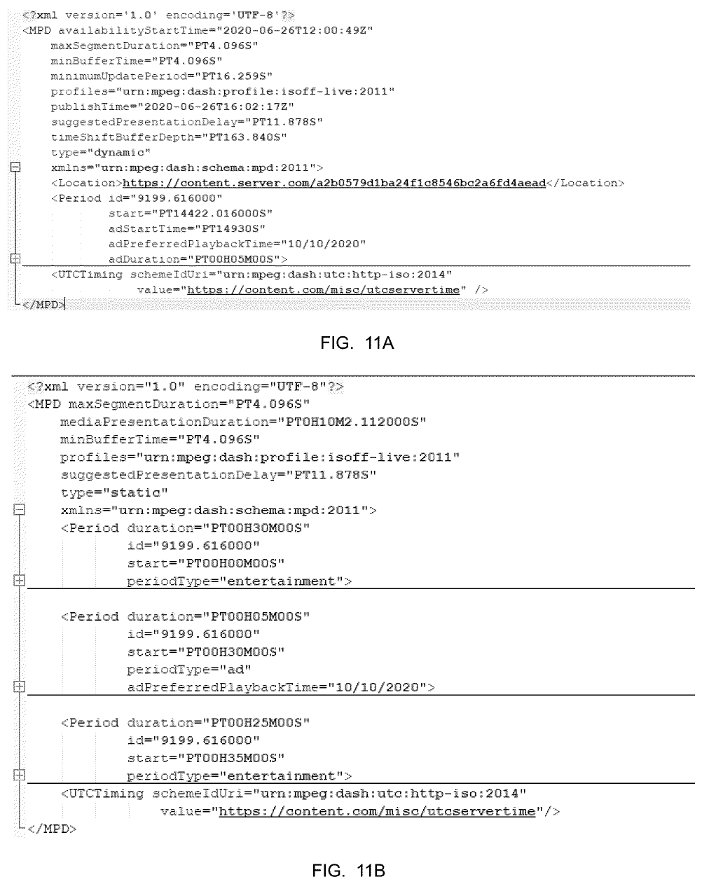

The server, while recording and recreating the MPD files for further consumption, recognizes the content and takes necessary steps to replace the content if applicable. Representations of an MPD with custom tags, as stored in an entertainment content server, are shown in FIG. 11A and FIG. 11B.

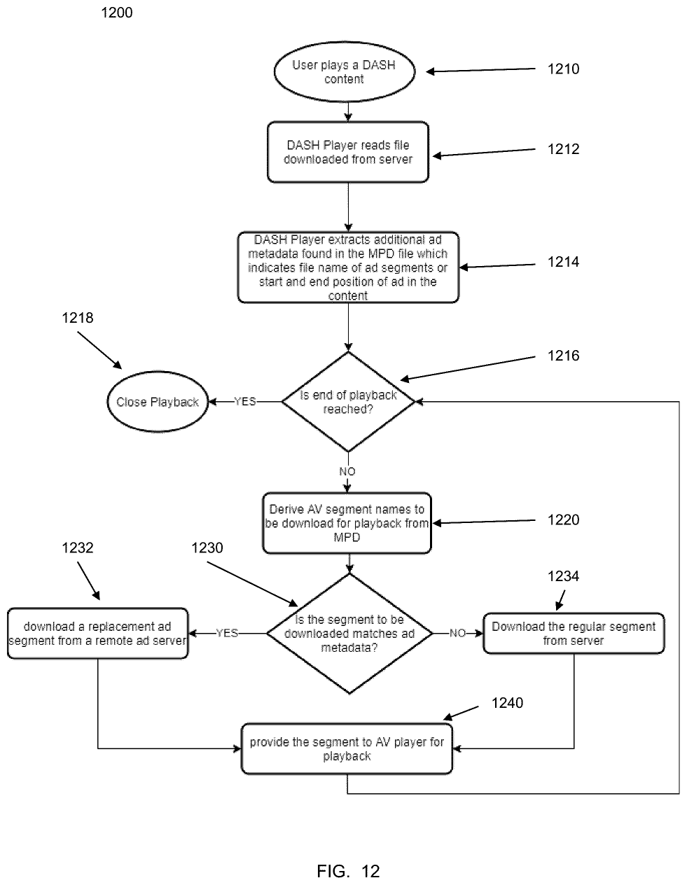

FIG. 12 shows an exemplary method 1200 for selectively changing part of the content on a MPD file, in accordance with an exemplary embodiment of the present disclosure.

In step 1210, a user of a client device (such as 160, 165, or 170 of FIG. 1), has the device play DASH or other media content. This can be done by selecting a particular program from a menu or guide, which includes both recorded and live programs. Also a user could resume viewing of a program that has been played previously.

In step 1212, a DASH player, in the media device's application, reads a file downloaded from the external digital media server and stored on the storage associated with the media device. In step 1214, the DASH player then extracts supplemental content metadata found in the MPD file which indicates file names of supplemental content segments or start and end positions of a supplemental content in the content. If the end of playback has not been reached (step 1216), then the media device performs additional processing on the MPD file, otherwise the playback of the content is ended (step 1218).

In step 1220, AV segment names are derived from the MPD file and the segments are downloaded from the digital media server. Based on these segment names in step 1230, a determination is made. If the segment matches supplemental content metadata (step 1232) then a replacement segment is retrieved from the supplemental content server. The particular supplemental content being determined either by the metadata or from details retrieved from the operator's cloud or other external network location. If the segment does not match supplemental content metadata, then the next regular segment is downloaded in step 1234 from the digital media server or stored content of the media device.

In step 1240, the Dash player prepares the file that is to be provided to the client device for playback. Based on the determination in step 1230 the segment is either sourced from the supplemental content server (step 1232) or the digital media server (1234). This resulting file can then be viewed and/or listened to on the client device by a user.

Techniques consistent with the preset disclosure provide, among other features, systems and methods for providing supplemental content in a digital media based on local and temporal considerations. Further the present disclosure could be used with other purpose built devices instead of or in addition to a media server. While various exemplary embodiment of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth of scope.

What is claimed is:

1. A system for providing supplemental content and media comprising:
a media device;
an external digital media server;
an supplemental content server;
the media device is configured to:
request and receive digital media from the external digital media server;
request and receive supplemental content from the supplemental content server;
store the digital media and supplemental content in storage associated with the media device;
produce by the media device based at least on supplemental content criteria received from an external source, a combined media comprising of the digital media received from the external server and supplemental content from the supplemental content server; and
store the combined media in the storage associated with the media device for either immediate or later provision to a client's playback device and/or display.

2. The system of claim 1, wherein the media device is at least one of a media server, cable headend, application server, television, smart phone, and other user equipment.

3. The system of claim 1, wherein the digital media comprises of live or real-time content.

4. The system of claim 1, wherein the digital media is recorded on the media server in Dynamic Adaptive Streaming over HTTP (MPEG-DASH) format.

5. The system of claim 1, wherein the digital media is created dynamically every time a client requests playback of the content.

6. The system of claim 1, wherein the supplemental content criteria is based on, at least one of: the day and time, advertiser's and/or a client's preferences and profiles, and criteria selected by a service provider and/or original content creator.

7. The system of claim 6, wherein the supplemental content criteria can include an option to have no supplemental content added to the combined media by the media device.

8. The system of claim 1, wherein the supplemental content criteria is provided from a cloud server.

9. A method for providing supplemental content and media comprising the steps of:
requesting digital media, by a media device, from an external digital media server;
requesting supplemental content, by the media device, from a supplemental content server;
receiving said digital media, by the media device, from the external digital media server;
receiving said supplemental content, by the media device, from the supplemental content server;
storing, both the digital media, and the supplemental content in storage associated with the media device;
producing, by the media device, a combined media comprising of the digital media and supplemental content, based on at least supplemental content criteria received from an external source; and
storing the combined media in the storage associated with the media device for either immediate or later provision to a client's playback device and/or display.

10. The method of claim 9, wherein the digital media comprises of live or real-time content.

11. The method of claim 9, wherein the digital media is recorded on the media server in Dynamic Adaptive Streaming over HTTP (MPEG-DASH) format.

12. The method of claim 9, wherein the digital media is created dynamically every time a client requests playback of the content.

13. The method of claim 9, wherein the supplemental content criteria is based on, at least one of: the day and time, advertiser's and/or a client's preferences and profiles, and criteria selected by a service provider and/or original content creator.

14. The method of claim 13, wherein the supplemental content criteria can include an option to have no supplemental content added to the combined media by the media device.

15. A non-transitory computer readable media having instructions operable to cause one or more processors of a media device to perform operations for providing supplemental content and media comprising the steps of:
requesting digital media, by a media device, from an external digital media server;
requesting advertisement, by the media device, from a supplemental content server;
receiving said digital media, by the media device, from the external digital media server;
receiving said supplemental content, by the media device, from the supplemental content server;
storing, both the digital device and the supplemental content in storage associated with the media device;
producing, by the media device, a combined media comprising of the digital media and supplemental content based on at least supplemental content criteria received from an external source; and
storing the combined media in the storage associated with the media device for either immediate or later provision to a client's playback device and/or display.

16. The non-transitory computer readable media of claim 15, wherein the digital media comprises of live or real-time content.

17. The non-transitory computer readable media of claim 15, wherein the digital media is recorded on the media server in Dynamic Adaptive Streaming over HTTP (MPEG-DASH) format.

18. The non-transitory computer readable media of claim 15, wherein the digital media is created dynamically every time a client request playback of the content.

19. The non-transitory computer readable media of claim 15, wherein the supplemental content criteria is based on, at least one of: the day and time, advertiser's and/or a client's preferences and profiles, and criteria selected by a service provider and/or original content creator.

20. The non-transitory computer readable media of claim 19, wherein the supplemental content criteria can include an option to have no supplemental content added to the combined media by the media device.
